(19) United States
(12) Patent Application Publication
(10) Pub. No.: US 2026/0269546 A1
(43) Pub. Date: Sep. 10, 2026

(54) CONNECTOR COMBINATION TERMINAL, CONNECTOR AND CONNECTOR ASSEMBLY

(71) Applicant: Tyco Electronics (Shanghai) Co., Ltd., Shanghai (CN)

(72) Inventors: Jiaoyong (Mac) Liu, Shanghai (CN); Jie (Roger) Luo, Foshan (CN); Rong(Summer) Zhang, Shenzhen (CN); William (Wei) Yao, Kunshan (CN)

(73) Assignee: Tyco Electronics (Shanghai) Co., Ltd., Shanghai (CN)

(21) Appl. No.: 19/557,329

(22) Filed: Mar. 5, 2026

(30) Foreign Application Priority Data
Mar. 5, 2025 (CN) 202510260082.1

(51) Int. Cl. H01R 25/14; H01R 13/115; H01R 13/50; H01R 25/16

(52) U.S. Cl. CPC H01R 25/142; H01R 13/115; H01R 13/50; H01R 25/162

(57) ABSTRACT

A connector combination terminal comprises a first terminal and a second terminal. The first terminal includes a first bottom plate and a first cantilever connected to the first bottom plate. The second terminal includes a second bottom plate and a second cantilever connected to the second bottom plate. The second terminal is arranged on an inner side of the first terminal. The second bottom plate is stacked and fixed onto an inner side of the first bottom plate. An end of the first cantilever and an end of the second cantilever are adjacent in a height direction and are adapted to connect to a first busbar.

### CROSS-REFERENCE TO RELATED APPLICATION

This application claims the benefit of Chinese Patent Application No. CN202510260082.1 filed on Mar. 5, 2025 in the State Intellectual Property Office of China, the whole disclosure of which is incorporated herein by reference.

### FIELD OF THE INVENTION

The disclosure relates to a connector combination terminal, a connector comprising the connector combination terminal, and a connector assembly comprising the connector.

### BACKGROUND OF THE INVENTION

In the prior art, a connector typically consists of a housing and a terminal housed within the housing. The terminal comprises a pair of mutually separated elastic arms, which are used to clamp a busbar inserted between them, thereby achieving electrical connection between the terminal and the busbar. The terminal typically has a single-layer structure and only a pair of electrical contacts, which limits its current-carrying capacity and prevents it from carrying higher current, such as 500 A or higher. To enhance current-carrying capacity, the prior art can only increase the size of the terminal, which is not conducive to the miniaturization of connector.

### SUMMARY OF THE INVENTION

According to an embodiment of the present disclosure, a connector combination terminal comprises a first terminal and a second terminal. The first terminal includes a first bottom plate and a first cantilever connected to the first bottom plate. The second terminal includes a second bottom plate and a second cantilever connected to the second bottom plate. The second terminal is arranged on an inner side of the first terminal. The second bottom plate is stacked and fixed onto an inner side of the first bottom plate. An end of the first cantilever and an end of the second cantilever are adjacent in a height direction and are adapted to connect to a first busbar.

### BRIEF DESCRIPTION OF DRAWINGS

The above and other features of the present invention will become more apparent by describing in detail exemplary embodiments thereof with reference to the accompanying drawings, in which:

FIG. 1 shows an illustrative perspective view of a connector assembly according to an exemplary embodiment of the present invention;

FIG. 2 shows a cross-sectional view of a connector assembly according to an exemplary embodiment of the present invention;

FIG. 3 shows an illustrative perspective view of a connector according to an exemplary embodiment of the present invention;

FIG. 4 shows an illustrative exploded view of a connector according to an exemplary embodiment of the present invention;

FIG. 5 shows an illustrative perspective view of a connector combination terminal according to an exemplary embodiment of the present invention;

FIG. 6 shows a cross-sectional view of a connector combination terminal according to an exemplary embodiment of the present invention;

FIG. 7 shows an illustrative perspective view of a first terminal according to an exemplary embodiment of the present invention;

FIG. 8 shows a plan sectional view of a first terminal according to an exemplary embodiment of the present invention;

FIG. 9 shows an illustrative perspective view of a second terminal according to an exemplary embodiment of the present invention;

FIG. 10 shows a plan cross-sectional view of a second terminal according to an exemplary embodiment of the present invention;

FIG. 11 shows an illustrative view of the mating of a connector combination terminal with a first busbar according to an exemplary embodiment of the present invention;

FIG. 12 shows an illustrative perspective view of a connector combination terminal according to another exemplary embodiment of the present invention; and

FIG. 13 shows an illustrative view of the mating of a connector combination terminal with a first busbar according to another exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general concept of the present invention, there is provided a connector combination terminal. The connector combination terminal comprises: a first terminal comprising a first bottom plate and a first cantilever which is connected to the first bottom plate; and a second terminal comprising a second bottom plate and a second cantilever which is connected to the second bottom plate. The second terminal is located on the inner side of the first terminal, and the second bottom plate is stacked and fixed onto the inner side of the first bottom plate, the end of the first cantilever and the end of the second cantilever are adjacent in a height direction for electrical contact with a first busbar.

According to another general concept of the present invention, there is provided a connector. The connector comprises: an insulation housing having a bottom opening and a top socket opposite to the bottom opening; and the above connector combination terminal installed in the insulation housing through the bottom opening. The first terminal and the second terminal of the connector combination terminal are adapted to simultaneously clamp the first busbar inserted through the top socket.

According to another general concept of the present invention, there is provided a connector assembly. The connector assembly comprises: the above connector; and a first busbar that is inserted into the connector through the top socket of the insulation housing of the connector. The pair of first cantilevers of the first terminal and the pair of second cantilevers of the second terminal simultaneously clamp the first busbar to achieve electrical connection between the connector combination terminal and the first busbar.

According to another general concept of the present invention, a connector combination terminal is provided. The connector combination terminal comprises: a first terminal and a second terminal. The first terminal includes: a first bottom plate having two opposite sides in its width direction; and a pair of first cantilevers respectively connected to the two sides of the first bottom plate, for clamping a first busbar inserted between them. The second terminal includes: a second bottom plate having two opposite sides in its width direction; and a pair of second cantilevers respectively connected to the two sides of the second bottom plate, for clamping the first busbar inserted between them. The second terminal is located on the inner side of the first terminal, and the second bottom plate is stacked and fixed onto the inner side of the first bottom plate. The end of one first cantilever and the end of one second cantilever are adjacent in the height direction, for electrical contact with one side of the first busbar. The end of the other first cantilever and the end of the other second cantilever are adjacent in the height direction, for electrical contact with the other side of the first busbar.

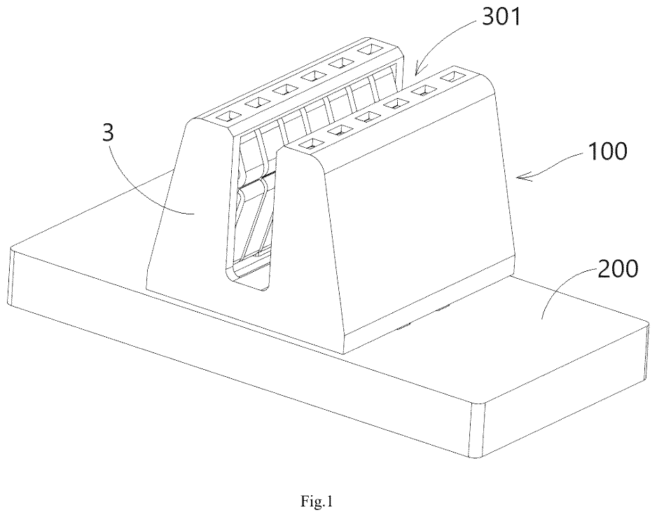

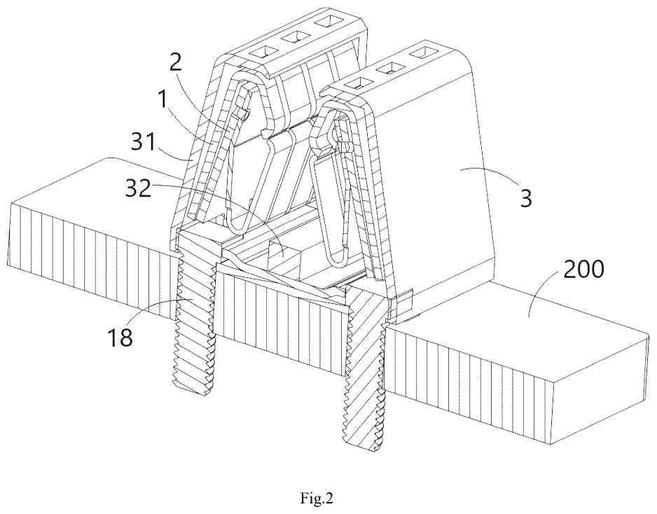

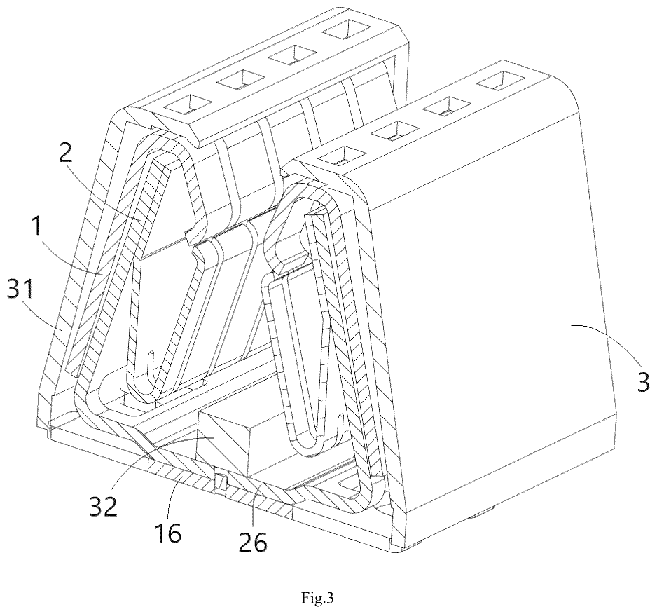

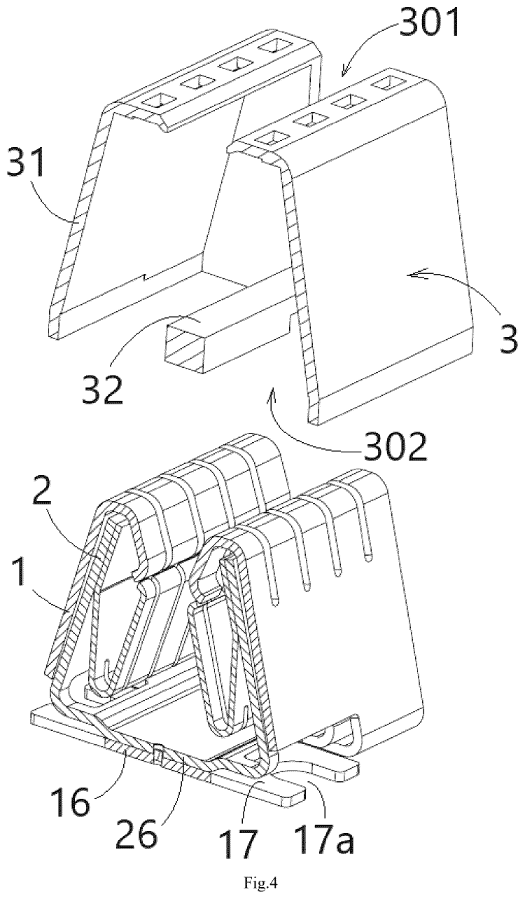

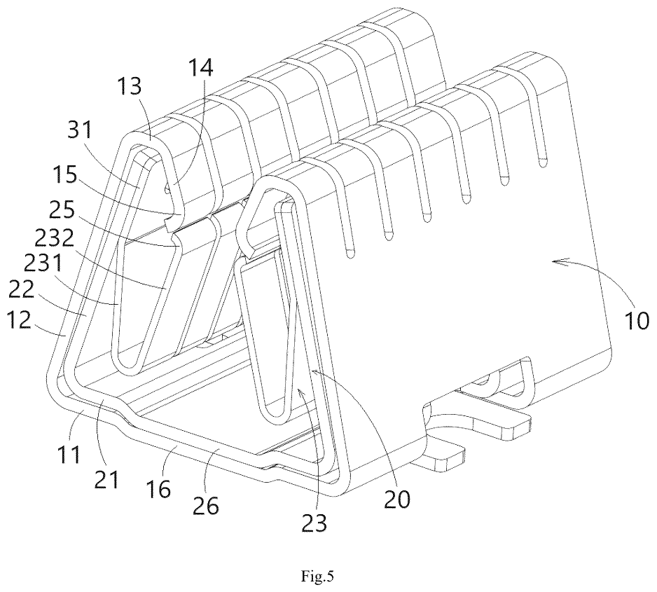

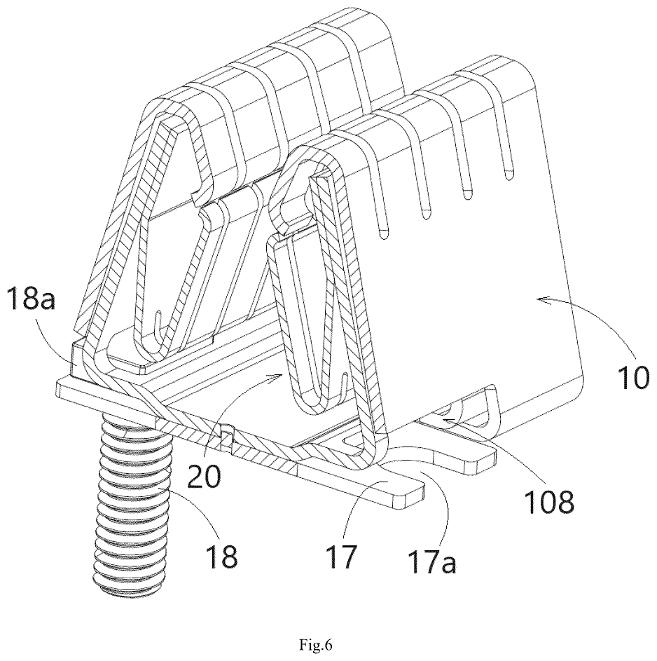

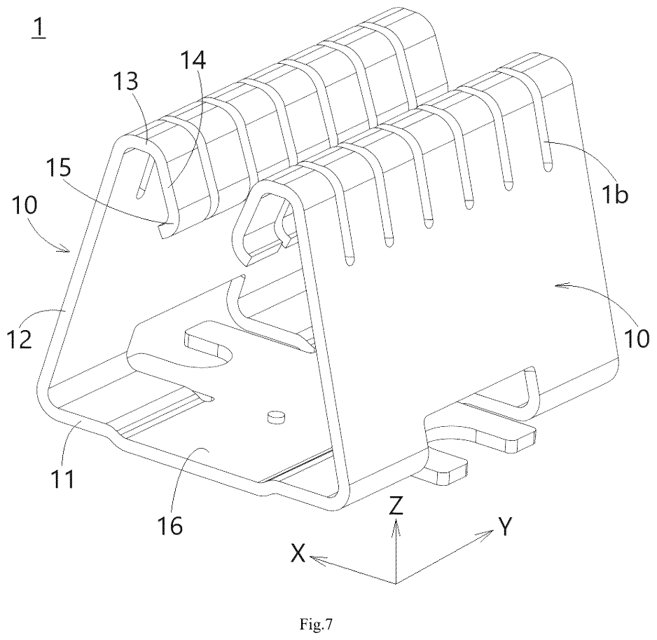

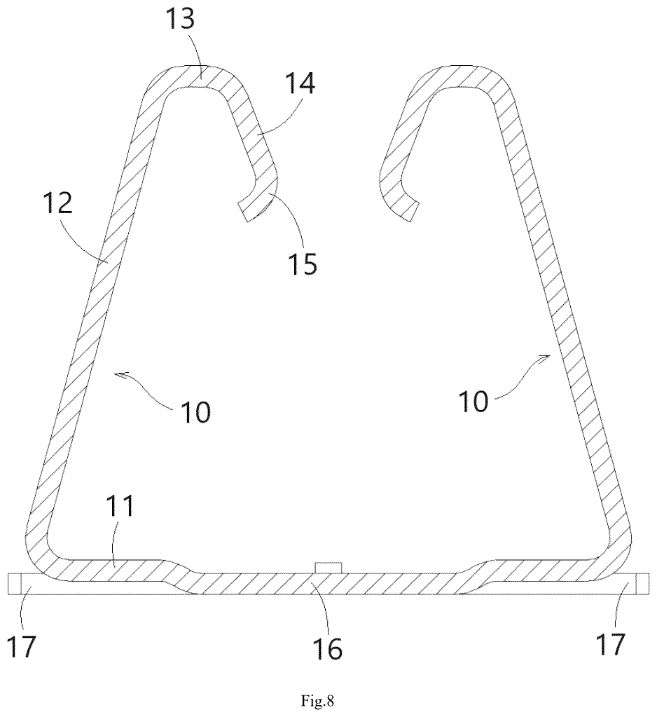

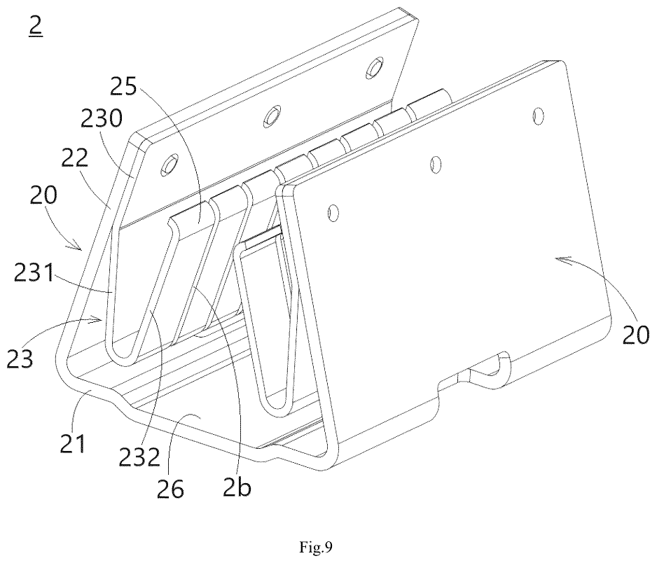

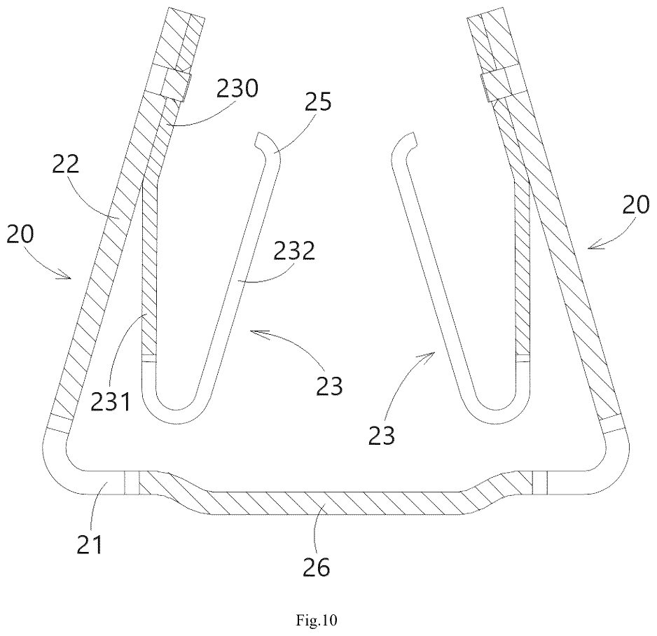

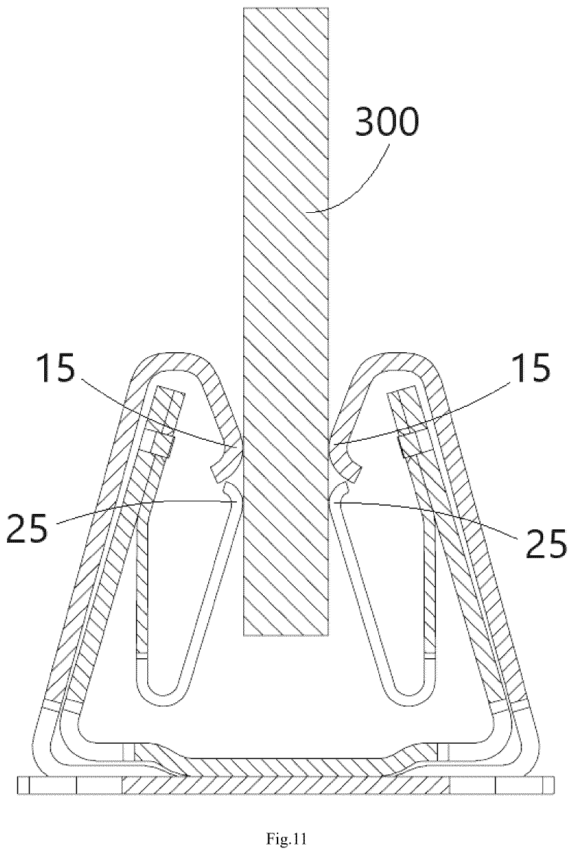

FIG. 1 shows an illustrative perspective view of a connector assembly according to an exemplary embodiment of the present invention; FIG. 2 shows a cross-sectional view of the connector assembly according to an exemplary embodiment of the present invention; FIG. 3 shows an illustrative perspective view of a connector according to an exemplary embodiment of the present invention; FIG. 4 shows an illustrative exploded view of the connector according to an exemplary embodiment of the present invention; FIG. 5 shows an illustrative perspective view of a connector combination terminal according to an exemplary embodiment of the present invention; FIG. 6 shows a cross-sectional view of the connector combination terminal according to an exemplary embodiment of the present invention; FIG. 7 shows an illustrative perspective view of the first terminal 1 according to an exemplary embodiment of the present invention; FIG. 8 shows a plan cross-sectional view of the first terminal 1 according to an exemplary embodiment of the present invention; FIG. 9 shows an illustrative perspective view of the second terminal 2 according to an exemplary embodiment of the present invention; FIG. 10 shows a plan cross-sectional view of the second terminal 2 according to an exemplary embodiment of the present invention; FIG. 11 shows an illustrative view of the mating of the connector combination terminal with the first busbar 300 according to an exemplary embodiment of the present invention.

As shown in FIGS. 1 to 11, in an exemplary embodiment of the present invention, a connector combination terminal is disclosed. The connector combination terminal comprises: a first terminal 1 and a second terminal 2. The first terminal 1 includes: a first bottom plate 16 and a pair of first cantilevers 10. The first bottom plate 16 has two opposite sides in its width direction X. The pair of first cantilevers 10 are respectively connected to both sides of the first bottom plate 16, for clamping a first busbar 300 inserted between them. The second terminal 2 includes: a second bottom plate 26 and a pair of second cantilevers 20. The second bottom plate 26 has two opposite sides in its width direction X. The pair of second cantilevers 20 are respectively connected to both sides of the second bottom plate 26, for clamping a first busbar 300 inserted between them.

As shown in FIGS. 1 to 11, in the illustrated embodiment, the second terminal 2 is located on the inner side of the first terminal 1, and the second bottom plate 26 is stacked and fixed onto the inner side (i.e., the top surface) of the first bottom plate 16. For example, the second bottom plate 26 can be riveted or welded onto the inner side of the first bottom plate 16. The end of one first cantilever 10 and the end of one second cantilever 20 are adjacent in the height direction Z, for electrical contact with one side of the first busbar 300. The end of the other first cantilever 10 and the end of the other second cantilever 20 are adjacent in the height direction Z, for electrical contact with the other side of the first busbar 300.

As shown in FIGS. 1 to 11, in the illustrated embodiment, the first cantilever 10 comprises: a first lower elastic arm 11, a first inclined arm 12, a first upper elastic arm 13, and a first guiding arm 14. One end of the first lower elastic arm 11 is connected to the first bottom plate 16 and extends in the width direction X. The lower end of the first inclined arm 12 is connected to the other end of the first lower elastic arm 11 and extends obliquely upward. One end of the first upper elastic arm 13 is connected to the upper end of the first inclined arm 12 and extends in the width direction X. The first guiding arm 14 is connected to the other end of the first upper elastic arm 13 and extends obliquely downward. The distal end of the first guiding arm 14 is used for electrical contact with the first busbar 300.

As shown in FIGS. 1 to 11, in the illustrated embodiment, the end of the first guiding arm 14 is bent into an arc shape, serving as a first electrical contact part 15 for electrical contact with the first busbar 300.

As shown in FIGS. 1 to 11, in the illustrated embodiment, the spacing between the upper ends of the first inclined arms 12 of a pair of first cantilevers 10 is smaller than the spacing between the lower ends of the first inclined arms 12 of the pair of first cantilevers 10. The spacing between the ends of the pair of first cantilevers 10 is slightly smaller than the thickness of the first busbar 300, allowing for simultaneous electrical contact with both sides of the first busbar 300 inserted between them.

As shown in FIGS. 1 to 11, in the illustrated embodiment, the first terminal 1 is an integral stamped terminal formed by stamping a single sheet of metal material. The first cantilever 10 is in the shape of a bent plate, making the first terminal 1 resemble a dovetail clip.

As shown in FIGS. 1 to 11, in the illustrated embodiment, multiple first dividing slits 1b are formed on the upper part of the first cantilever 10, and these first dividing slits 1b are spaced apart along the length direction Y of the first bottom plate 16. These first dividing slits 1b extend from the upper part of the first inclined arm 12 all the way to the end of the first cantilever 10, giving the upper part of the first cantilever 10 a comb-like appearance.

As shown in FIGS. 1 to 11, in the illustrated embodiment, the connector combination terminal further comprises a pair of connection ears 17. The pair of connection ears 17 are respectively connected to both sides of the first bottom plate 16. A slot hole 17a allowing a bolt 18 to pass through is formed in the connection ear 17, so that the first terminal 1 can be fastened to a second busbar 200 by the bolt 18 to electrically connect with the second busbar 200.

As shown in FIGS. 1 to 11, in the illustrated embodiment, the slot hole 17a in the connection ear 17 is a U-shaped hole that is open on the outside. An opening 108 for accommodating the head 18a of the bolt 18 is formed at the bottom of the first cantilever 10 and the second cantilever 20, and the connection ear 17 is located in the opening 108.

As shown in FIGS. 1 to 11, in the illustrated embodiment, the connector combination terminal further includes a bolt 18, which passes through the slot hole 17a in the connection ear 17 of the first terminal 1, for fastening the first bottom plate 16 of the first terminal 1 to the second busbar 200.

As shown in FIGS. 1 to 11, in the illustrated embodiment, when the first terminal 1 is fastened to the second busbar 200 via the bolt 18, the first bottom plate 16 of the first terminal 1 makes electrical contact with the top surface of the second busbar 200, and there is a predetermined gap between the first lower elastic arm 11 and the top surface of the second busbar 200.

As shown in FIGS. 1 to 11, in the illustrated embodiment, the second cantilever 20 comprises a second lower elastic arm 21, a second inclined arm 22, and a V-shaped elastic arm 23. One end of the second lower elastic arm 21 is connected to the second bottom plate 26 and extends in the width direction X. The lower end of the second inclined arm 22 is connected to the other end of the second lower elastic arm 21 and extends obliquely upward. One end of the V-shaped elastic arm 23 is connected to the upper end of the second inclined arm 22. The other end of the V-shaped elastic arm 23 is used for electrical contact with the first busbar 300.

As shown in FIGS. 1 to 11, in the illustrated embodiment, the second lower elastic arm 21 and the second inclined arm 22 are respectively stacked on the inner side of the first lower elastic arm 11 and the first inclined arm 12, and are adapted to abut against the inner side of the first lower elastic arm 11 and the first inclined arm 12, respectively.

As shown in FIGS. 1 to 11, in the illustrated embodiment, the spacing between the upper ends of the second inclined arms 22 of a pair of second cantilevers 20 is smaller than the spacing between the lower ends of the second inclined arms 22 of the pair of second cantilevers 20. The spacing between the ends of the pair of second cantilevers 20 is slightly smaller than the thickness of the first busbar 300, allowing for simultaneous electrical contact with both sides of the first busbar 300 inserted between them.

As shown in FIGS. 1 to 11, in the illustrated embodiment, the V-shaped elastic arm 23 comprises: a fixing plate 230, a second elastic arm 231, and a second guiding arm 232. The fixing plate 230 is fixed to the inner side of the upper end of the second inclined arm 22. The second elastic arm 231 is connected to the fixing plate 230 and extends downward. The second guiding arm 232 is connected to the lower end of the second elastic arm 231 and extends obliquely upward. The second guiding arm 232 is located below the first guiding arm 14, and the end of the second guiding arm 232 is used for electrical contact with the first busbar 300.

As shown in FIGS. 1 to 11, in the illustrated embodiment, the end of the second guiding arm 232 is bent into an arc shape, serving as a second electrical contact part 25 for electrical contact with the first busbar 300.

As shown in FIGS. 1 to 11, in the illustrated embodiment, the second bottom plate 26, the second lower elastic arm 21, and the second inclined arm 22 of the second terminal 2 are formed as a single piece, while the V-shaped elastic arm 23 is a one-piece stamped component.

As shown in FIGS. 1 to 11, in the illustrated embodiment, multiple second dividing slits 2b are formed on the second guiding arm 232, and these dividing slits 2b are spaced apart along the length direction Y of the second bottom plate 26. These second dividing slits 2b extend from the lower end of the second guiding arm 232 to its end, giving the second guiding arm 232 a comb-like appearance.

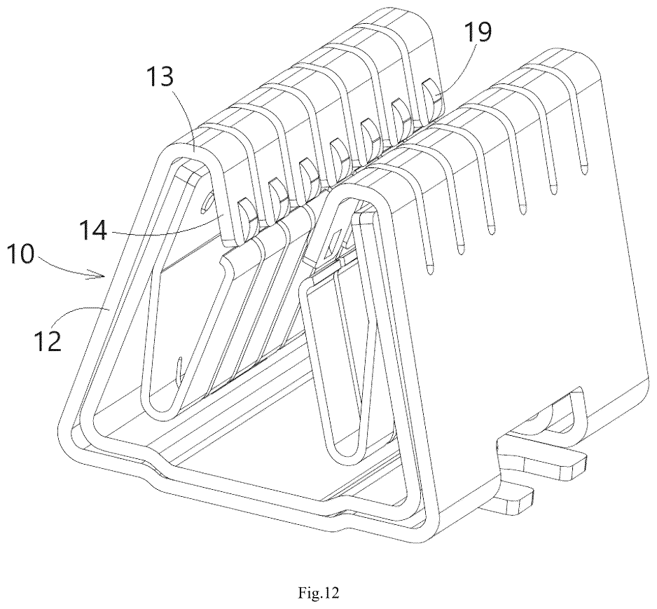

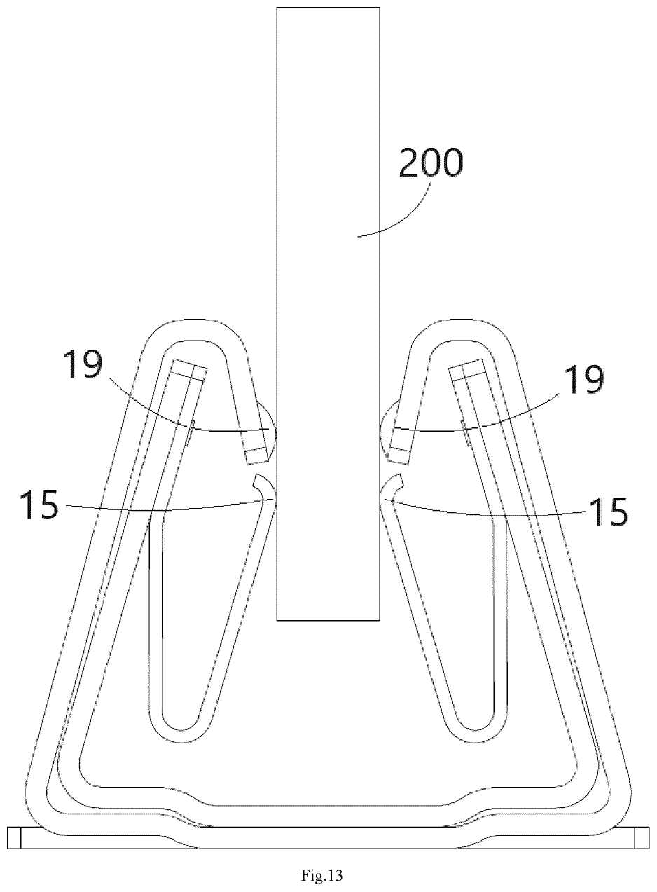

FIG. 12 shows an illustrative perspective view of a connector combination terminal according to another exemplary embodiment of the present invention; FIG. 13 shows an illustrative view of the connector combination terminal according to another exemplary embodiment of the present invention mated with a first busbar 200. The difference between the connector combination terminals shown in FIG. 12 and FIG. 13 and those shown in FIG. 1 to FIG. 11 lies only in the structure of the first cantilever 10 that makes electrical contact with the first busbar 200. The other technical features of the connector combination terminals shown in FIG. 12 and FIG. 13 are basically the same as those shown in FIG. 1 to FIG. 11, and reference can be made to the connector combination terminals shown in FIG. 1 to FIG. 11.

As shown in FIGS. 12 and 13, in the illustrated embodiment, multiple contact protrusions 19 are formed on the end of the first guiding arm 14. These contact protrusions 19 are aligned in a row along the length direction of the first bottom plate 16, serving to electrically contact the first busbar 300. Compared to the curved first electrical contact part 15 shown in FIGS. 1 to 11, the contact protrusions 19 depicted in FIGS. 12 and 13 offer the following advantages: the contact protrusions 19 occupy less space, which is more conducive to adjusting the distance between the electrical contact points of the first cantilever 10 and the second cantilever 20. The smaller this distance, the smaller the gold-plated area on the first busbar 200 for electrical contact with the connector combination terminal will be, resulting in lower cost. For the connector combination terminal, only the contact protrusions 19 need to be gold-plated, requiring less gold-plating material and thus offering better cost efficiency. Furthermore, compared to the curved first electrical contact part 15, the contact protrusions 19 use less material, leading to further cost savings.

As shown in FIGS. 1 to 13, in another exemplary embodiment of the present invention, a connector is also disclosed. The connector comprises: an insulation housing 3 and the aforementioned connector combination terminal. The insulation housing 3 has a bottom opening 302 and a top socket 301 opposite to the bottom opening 302. The connector combination terminal is installed in the insulation housing 3 through the bottom opening 302. The first terminal 1 and the second terminal 2 of the connector combination terminal are adapted to simultaneously clamp a first busbar 300 inserted through the top socket 301.

As shown in FIGS. 1 to 13, in the illustrated embodiment, the insulation housing 3 comprises a side wall 31 enclosing an internal cavity and a connecting beam 32 connected to the bottom of the side wall 31. The connecting beam 32 extends along the length direction Y of the second bottom plate 26 of the second terminal 2 and abuts against the top surface of the second bottom plate 16 of the second terminal 2.

As shown in FIGS. 1 to 13, in another exemplary embodiment of the present invention, a connector assembly is also disclosed. The connector assembly comprises: a connector 100 and a first busbar 300. The first busbar 300 is inserted into the connector 100 through the top socket 301 of the insulation housing 3 of the connector 100. A pair of first cantilevers 10 of the first terminal 1 and a pair of second cantilevers 20 of the second terminal 2 simultaneously clamp the first busbar 300, achieving electrical connection between the connector combination terminal and the first busbar 300.

As shown in FIGS. 1 to 13, in the illustrated embodiment, the connector assembly further includes a second busbar 200. The first bottom plate 16 of the first terminal 1 is fastened to the second busbar 200 via bolts 18 and nuts (not shown) and is in electrical contact with the second busbar 200. The bolts 18 pass through the connection ears 17 of the first bottom plate 16 and the second busbar 200 in turn and are threadedly connected to the nuts.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector combination terminal, comprising:
a first terminal including a first bottom plate and a first cantilever connected to the first bottom plate; and
a second terminal arranged on an inner side of the first terminal and including a second bottom plate and a second cantilever connected to the second bottom plate, wherein the second bottom plate stacked and fixed onto an inner side of the first bottom plate, and an end of the first cantilever and an end of the second cantilever are adjacent in a height direction and are adapted to connect to a first busbar.

2. The connector combination terminal according to claim 1, wherein:
the first bottom plate has two opposite sides in its width direction, the first terminal includes a pair of first cantilevers respectively connected to both sides of the first bottom plate for clamping the first busbar inserted between them; and
the second bottom plate has two opposite sides in its width direction, the second terminal includes a pair of second cantilevers respectively connected to both sides of the second bottom plate for clamping the first busbar inserted therebetween.

3. The connector combination terminal according to claim 2, wherein the first cantilever comprises:
a first lower elastic arm having one end connected to the first bottom plate and extending in the width direction;
a first inclined arm having a lower end connected to another end of the first lower elastic arm and extending obliquely upwards;
a first upper elastic arm having one end connected to an upper end of the first inclined arm and extending in the width direction; and
a first guiding arm connected to another end of the first upper lower elastic arm and extending obliquely downward, an end of the first guiding arm is adapted for electrical contact with the first busbar.

4. The connector combination terminal according to claim 3, wherein the end of the first guiding arm is bent into an arc shape, serving as a first electrical contact part for electrical contact with the first busbar.

5. The connector combination terminal according to claim 3, wherein a plurality of contact protrusions are formed on the end of the first guiding arm, the contact protrusions aligned in a row along a length direction of the first bottom plate for electrical contact with the first busbar.

6. The connector combination terminal according to claim 3, wherein:
a spacing between the upper ends of the first inclined arms of the pair of first cantilevers is smaller than the spacing between the lower ends of the first inclined arms of the pair of first cantilevers; and
a spacing between the ends of the pair of first cantilevers is less than the thickness of the first busbar, allowing for simultaneous electrical contact with both sides of the first busbar inserted therebetween.

7. The connector combination terminal according to claim 3, wherein the first terminal is an integral stamped terminal formed by stamping a single sheet of metal material, the first cantilever is in the shape of a bent plate.

8. The connector combination terminal according to claim 3, wherein:
a plurality of first dividing slits are formed on the upper part of the first cantilever, and are spaced apart along the length direction of the first bottom plate; and
the multiple first dividing slits extend from the upper part of the first inclined arm to the end of the first cantilever.

9. The connector combination terminal according to claim 3, further comprising a pair of connection ears respectively connected to both sides of the first bottom plate, wherein a slot hole is formed in the connection ear.

10. The connector combination terminal according to claim 9, wherein the slot hole in the connection ear is a U-shaped hole with an open outer side, an opening for accommodating the head of the bolt is formed at the bottom of the first cantilever and the second cantilever, and the connection ear is located in the opening.

11. The connector combination terminal according to claim 8, further comprising a bolt that passes through the slot hole in the connection ear of the first terminal and is used to fasten the first bottom plate of the first terminal to the second busbar.

12. The connector combination terminal according to claim 9, wherein when the first terminal is fastened to the second busbar via the bolt, the first bottom plate of the first terminal makes electrical contact with the top surface of the second busbar, and a predetermined gap is defined between the first lower elastic arm and the top surface of the second busbar.

13. The connector combination terminal according to claim 3, wherein the second cantilever comprises:
a second lower elastic arm having one end connected to the second bottom plate and extending in the width direction;
a second inclined arm having a lower end connected to the other end of the second lower elastic arm and extending obliquely upwards; and
a V-shaped elastic arm having one end connected to the upper end of the second inclined arm, wherein another other end of the V-shaped elastic arm is adapted to electrically contact the first busbar.

14. The connector combination terminal according to claim 13, wherein the second lower elastic arm and the second inclined arm are respectively stacked on the inner sides of the first lower elastic arm and the first inclined arm, and are adapted to abut against the inner sides of the first lower elastic arm and the first inclined arm, respectively.

15. The connector combination terminal according to claim 13, wherein:
a spacing between the upper ends of the second inclined arms of the pair of second cantilevers is smaller than the spacing between the lower ends of the second inclined arms of the pair of second cantilevers; and
a spacing between the ends of the pair of second cantilevers is slightly smaller than the thickness of the first busbar.

16. The connector combination terminal according to claim 14, wherein the V-shaped elastic arm comprises:
a fixing plate fixed to the inner side of the upper end of the second inclined arm;
a second elastic arm connected to the fixing plate and extends downward; and
a second guiding arm connected to the lower end of the second elastic arm and extends obliquely upwards, the second guiding arm is located below the first guiding arm, and the end of the second guiding arm is used for electrical contact with the first busbar.

17. The connector combination terminal according to claim 16, wherein the end of the second guiding arm is bent into an arc shape, serving as a second electrical contact part for electrical contact with the first busbar.

18. The connector combination terminal according to claim 16, wherein the second bottom plate, the second lower elastic arm, and the second inclined arm of the second terminal are formed into a single piece, and the V-shaped elastic arm is a one-piece stamped component.

19. The connector combination terminal according to claim 18, wherein:
a plurality of second dividing slits are formed on the second guiding arm, and are distributed at intervals along the length direction of the second bottom plate; and
the multiple second dividing slits extend from the lower end of the second guiding arm to the end of the second guiding arm.

20. A connector, comprising:
an insulation housing having a bottom opening and a top socket opposite to the bottom opening; and
a connector combination installed in the insulation housing through the bottom opening, including:
a first terminal having a first bottom plate and a first cantilever connected to the first bottom plate; and
a second terminal having a second bottom plate and a second cantilever connected to the second bottom plate, wherein the second terminal is arranged on an inner side of the first terminal, and the second bottom plate is stacked and fixed onto an inner side of the first bottom plate, and an end of the first cantilever and an end of the second cantilever are adjacent in a height direction, the first terminal and the second terminal of the connector combination terminal are adapted to simultaneously clamp to a first busbar inserted through the top socket.

21. The connector according to claim 20, wherein the insulation housing comprises a side wall enclosing an internal cavity and a connecting beam connected to the bottom of the side wall, the connecting beam extends along the length direction of the second bottom plate of the second terminal and abuts against the top surface of the second bottom plate of the second terminal.

22. A connector according to claim 20, further comprising a first busbar that is inserted into the connector through the top socket of the insulation housing of the connector, wherein the pair of first cantilevers of the first terminal and the pair of second cantilevers of the second terminal simultaneously clamp to the first busbar.

23. The connector assembly according to claim 22, further comprising a second busbar, wherein the first bottom plate of the first terminal is fastened to the second busbar via a fastener.
